(19) United States
(12) Patent Application Publication
(10) Pub. No.: US 2011/0079450 A1
(43) Pub. Date: Apr. 7, 2011

(54) Small Device

(76) Inventor: Tatsuro Sakamoto, Fukaya-shi (JP)

(21) Appl. No.: 12/838,193

(22) Filed: Jul. 16, 2010

(30) Foreign Application Priority Data
Oct. 5, 2009 (JP) 2009-231987

(51) Int. Cl. G06F 3/041

(52) U.S. Cl. 178/18.03

(57) ABSTRACT

According to one embodiment, a small device includes a first touchpad, a second touchpad, a board and a housing. The first touchpad has a first input surface on a surface of the first touchpad. The second touchpad has a second input surface on a surface of the second touchpad. The second input surface allows a rubbing operation continuing from the first input surface of the first touchpad. The board has a first detector configured to detect push-down input from the first touchpad and second detector configured to detect input by the rubbing operation. The first detector is provided at a position where the first detection section is opposed to the first touchpad. The second detector is provided at a position where the second detection section is opposed to the second touchpad. The housing positions the second touchpad and the board and covers the board.

### CROSS-REFERENCE TO RELATED APPLICATIONS

This application is based upon and claims the benefit of priority from Japanese Patent Application No. 2009-231987, filed Oct. 5, 2009; the entire contents of which are incorporated herein by reference.

### FIELD

Embodiments described herein relate generally to a fail safe structure in a small device provided with a touchpad with a switch.

### BACKGROUND

As is known well, recent digital-television broadcast reception apparatuses have highly intelligent and diversified functions. Therefore, the number of operation keys provided on a remote controller for operating a broadcast reception apparatus has increasing.

Further, broadcast reception apparatuses are connected to external devices through networks. Users can perform operations interlocked with external devices by inputting operational instructions to the broadcast reception apparatuses by use of remote controllers. Users also can use the Internet from the broadcast reception apparatuses. Users operate motion of a pointer displayed on a display of a broadcast reception apparatus and text input by using a remote controller. Consequently, a remote controller which is only provided with operation keys is inconvenient to allow users free operations on a screen displayed on the display of the broadcast reception apparatus. Jpn. Pat. Appln. KOKAI Publication No. 2005-191695 discloses a configuration of a remote controller, which is capable of performing remote controls on plural electronic devices and can set a device as an operation target.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary top view schematically illustrating a remote controller according to an embodiment;

FIG. 2 is an exemplary top view of a printed board used in the remote controller according to the embodiment;

FIG. 3 is an exemplary top view of a rubber used in the remote controller according to the embodiment;

FIG. 4 is an exemplary top view or side view of a seal used in the remote controller according to the embodiment;

FIG. 5 is an exemplary top view illustrating a state in which the printed board and the rubber used in the remote controller are bonded according to the embodiment;

FIG. 6 is an exemplary top view of a touchpad used in the remote controller according to the embodiment; and

FIG. 7 is an exemplary cross-sectional view of the remote controller according to the embodiment, cut along a line X-X in FIG. 1.

### DETAILED DESCRIPTION

Various embodiments will be described hereinafter with reference to the accompanying drawings.

In general, according to one embodiment, a small device includes a first touchpad, a second touchpad, a board and a housing. The first touchpad has a first input surface on a surface of the first touchpad. The second touchpad has a second input surface on a surface of the second touchpad. The second input surface allows a rubbing operation continuing from the first input surface of the first touchpad. The board has a first detector configured to detect push-down input from the first touchpad and second detector configured to detect input by the rubbing operation. The first detector is provided at a position where the first detection section is opposed to the first touchpad. The second detector is provided at a position where the second detection section is opposed to the second touchpad. The housing positions the second touchpad and the board and covers the board.

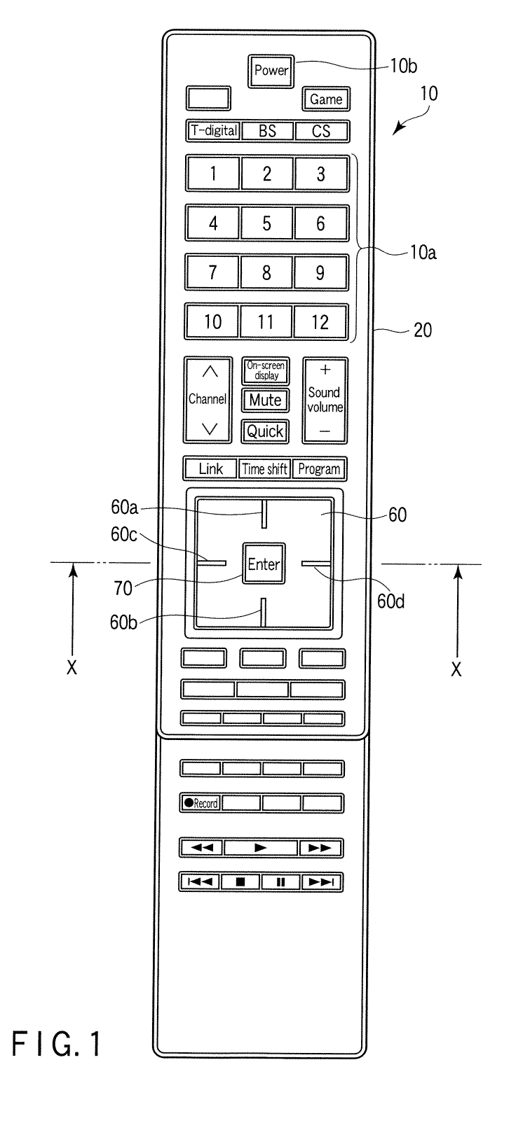

Hereinafter, an embodiment will be described with reference to the drawings. FIG. 1 is a top view schematically illustrating a remote controller 10 according to the embodiment. In the remote controller 10, plural operation keys protrude from inside a rectangular housing 20. The operation keys are, for example, channel keys 10a to select a channel to watch. A user inputs operation instructions by pushing down the operation keys. A surface of the remote controller 10 where the operation keys protrude during normal use is defined as an top surface. An opposite surface to the top surface is defined as a bottom surface. Further, a side of the remote controller 10 where a power key 10b is provided is defined as a front side. An opposite side to the front side is defined as a rear side.

Further, a touchpad 60 and an enter key 70 are provided in the top surface side of the remote controller 10. The touchpad 60 is an electrostatic pad of electrostatic capacity type. The top surface side of the touchpad 60 or, in other words, a part which the user directly rubs with a finger to operate is covered with a non-dielectric material. The touchpad 60 and the housing 20 are formed of respectively separate members. The touchpad 60 and the housing 20 are engaged with each other inside the remote controller 10.

The enter key 70 is used to enter a choice. The enter key 70 is provided to protrude from the top surface side of the housing 20. Top surfaces of the touchpad 60 and enter key 70 are in a substantially equal horizontal plane.

The top surface of the touchpad 60 is rectangular. The enter key 70 is provided at a center part of the touchpad 60. The touchpad 60 and enter key 70 are formed of respectively separate members. The touchpad 60 and the enter key 70 are engaged with each other inside the remote controller 10.

Centers and ends of four edges of the touchpad 60 respectively form direction keys (push buttons). The direction keys are used to move a cursor. An up key 60a is provided in the front side relative to the enter key 70 as a center, a down key 60b in the rear side, a left key 60c in the left side, as well as a right key 60d in the right side. The direction keys can be moved down and up as the user pushes down the direction keys. That is, the direction keys are provided within an area of the touchpad 60.

The touchpad 60 is used to input gesture patterns for moving the cursor, inputting text, and turning pages. The touchpad 60 detects not only strokes of fingers within the area of the touchpad 60 but also strokes which the user creates by continuously rubbing an area of the touchpad 60 including any of the direction keys and an area of the enter key 70 with fingers. That is, the user can input the gesture patterns from whole areas of the touchpad 60 and enter key 70 including the direction keys.

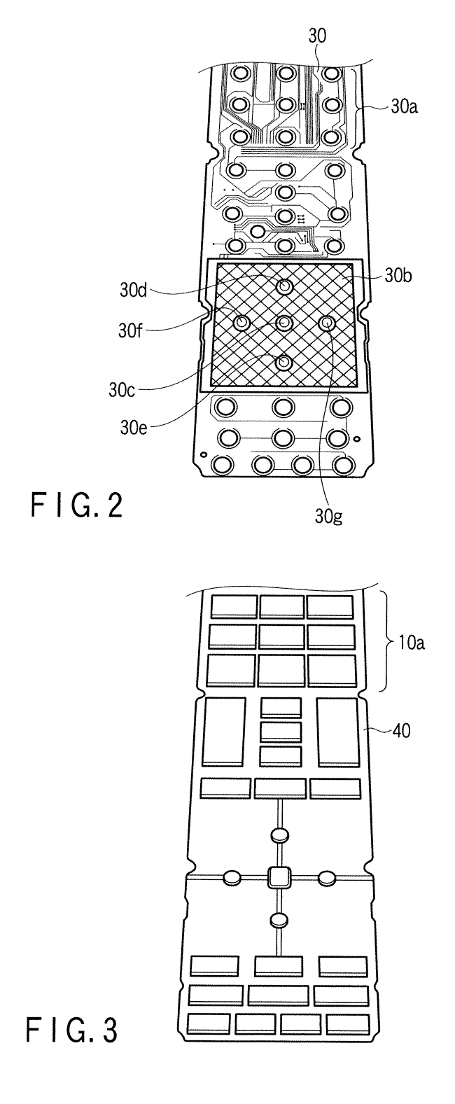

Next, an interior structure of the remote controller 10 will be described. FIG. 2 is a top view schematically illustrating a printed board 30 used in the remote controller 10. The printed board 30 is provided with, for example, channel-key metal domes 30a, an touchpad electrode 30b, a the enter key metal dome 30c, an up-key metal dome 30d, a down-key metal dome 30e, a left-key metal dome 30f, and a right-key metal dome 30g.

The channel-key metal domes 30a form a detection module which detects input in response to a push down on any of the channel keys 10a. The channel-key metal domes 30a each semispherically protrude from the printed board 30 toward the top surface side. The other metal domes are configured in the same manner as described above. The number of the metal domes corresponds to the number of the operation keys illustrated in FIG. 1.

The touchpad electrode 30b is a detection module (a second detector) which detects traces of gesture patterns in the area of the touchpad 60 including the direction keys and the areas thereof including the enter key 70. The area of the touchpad electrode 30b has substantially the same size as the touchpad 60 opposed to the electrode 30b. The enter-key metal dome 30c is a detection module (a first detector) which detects input in response to a push down on the enter key 70. The up-key metal dome 30d is a detection module (a third detector) which detects input in response to a push down on the up key 60a. The down-key metal dome 30e is a detection module (also, a third detector) which detects input in response to a push down on the up key 60b. The left-key metal dome 30f is a detection module (also, a third detector) which detects input in response to a push down on the left key 60c. The right-key metal dome 30g is a detection module (third detector) which detects input in response to a push down on the right key 60d.

The enter-key metal dome 30c, up-key metal dome 30d, down-key metal dome 30e, left-key metal dome 30f, and right-key metal dome 30g are provided within the area of the touchpad electrode 30b.

The detection modules which detect touch operations and push down operations are provided on the printed board 30. These detection modules are located under the enter key 70, touchpad 60, and left right up and down keys 60a to 60d.

FIG. 3 is a top view schematically illustrating a rubber 40 (an elastic member) used in the remote controller 10. The rubber 40 is located on the top surface of the printed board 30. The rubber 40 is made of, for example, silicone rubber. The rubber 40 has a size large enough to cover all the metal domes provided on the printed board 30 where the rubber 40 is located on the top surface of the printed board 30. In the embodiment, the rubber 40 has substantially the same size as the printed board 30, and covers the whole surface of the printed board 30.

Operation keys such as channel keys 10a are bonded to the top surface of the rubber 40. The operation keys are bonded to the rubber 40 at positions where the operation keys are respectively opposed to corresponding ones of the metal domes when the rubber 40 is provided on the top surface of the printed board 30. The user can feel a click owing to elasticity of the rubber 40, for example, when the user pushes down the channel key 30a.

Further, the rubber 40 covers the area of the touchpad electrode 30b, where the rubber 40 is provided on the top surface of the printed board 30. This is because the channel-key metal domes 30a, up-key metal dome 30d, down-key metal dome 30e, left-key metal dome 30f, and right-key metal dome 30g, all of which need be covered with the rubber 40, are provided within the area of the touchpad electrode 30b.

Therefore, when the remote controller 10 provided with the touchpad 60a including the direction keys is manufactured for a low price, as in the embodiment, the rubber 40 need be provided at a position where the rubber 40 is opposed to the touchpad 60 and the touchpad electrode 30b.

Where the printed board 30, rubber 40, and touchpad 60 are simply located in this order, electrostatic capacity of the touchpad 60 may change and thereby cause an operation error of the touchpad 60. A cause of the operation error is that air bubbles generated between the printed board 30 and the rubber 40 move irregularly when the operation keys are pushed down. Another cause is that the rubber 40 itself is deformed and moved due to a push down on the operation keys. Therefore, electrostatic capacity of the touchpad 60 may irregularly change and possibly hinder the user from properly operating the touchpad 60.

Hence, in the embodiment, the printed board 30 and the rubber 40 are fixed by bonding. The printed board 30 and rubber 40 can be fixed by an adhesive agent. In this case, coating roughness of the adhesive agent is also a cause of the operation error of the remote controller 10. Hence, as a more preferred embodiment in view of simplicity and accuracy of bonding, the printed board 30 and rubber 40 may be fixed by a seal 50 (a double-faced adhesive member).

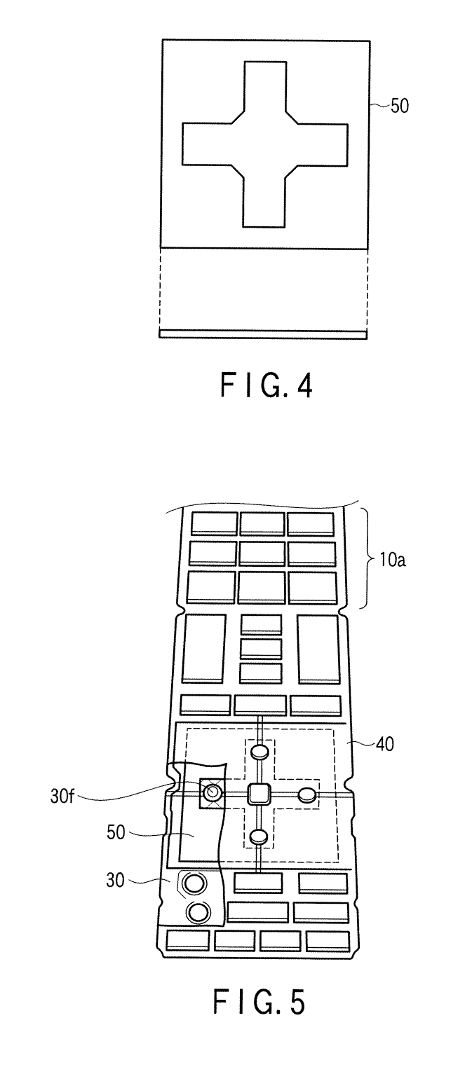

FIG. 4 illustrates top and side views of the seal 50. The seal 50 is a member which bonds an area of the touchpad electrode 30b on the printed board 30 and the rubber 40 opposed to this area. The seal 50 has substantially the same size as the area of the touchpad electrode 30b. The seal 50 is a double-faced adhesive seal of a thin film which has a uniform thickness. In the seal 50, an opening is formed in a cross shape which extends in directions perpendicular to each other, in lateral and longitudinal directions. Further, the opening in the seal 50 is larger at a part of the enter key metal dome 30c than at a part of the up-key metal dome 30d (as well as than at the down-key metal dome 30e, the left-key metal dome 30f, and the right-key metal dome 30g). This is because the enter key 70 particularly need be more pushed down than the direction keys.

The opening is provided in the seal 50 so as not cover any of the enter key metal dome 30c, up-key metal dome 30d, down-key metal dome 30e, left-key metal dome 30f, and right-key metal dome 30g, which are provided within the area of the touchpad electrode 30b, when the seal 50 is bonded to the area of the touchpad electrode 30b. For example, if the enter-key metal dome 30c and the printed board 30 are bonded, a click feel which is created when the user pushes down the enter key 70 deteriorates. The same as described above applies also to parts of the other metal domes.

The shape of the seal 50 is not limited to that illustrated in FIG. 4 insofar as the area of the printed board 30 corresponding to the touchpad electrode 30b and the rubber 40 can be fixed. Further, the shape of the opening in the seal 50 is not limited to the cross shape described above insofar as none of the enter-key metal dome 30c, up-key metal dome 30d, down-key metal dome 30e, left-key metal dome 30f, and right-key metal dome 30g is covered.

The seal 50 is bonded at a uniform thickness maintained along a horizontal plane between the area of the printed board 30 corresponding to the touchpad electrode 30b and the rubber 40.

FIG. 5 is a top view schematically illustrating a state in which the printed board 30 and the rubber 40 are bonded by the seal 50 where the rubber 40 is partially cut out. The rubber 40 is bonded to the printed board 30 by the seal 50 only in the area of the touchpad electrode 30b. Further, the enter-key metal dome 30c, up-key metal dome 30d, down-key metal dome 30e, left-key metal dome 30f, and right-key metal dome 30g, which are provided within the area of the touchpad electrode 30b, are opposed directly to the rubber 40 without the seal 50 inserted in between.

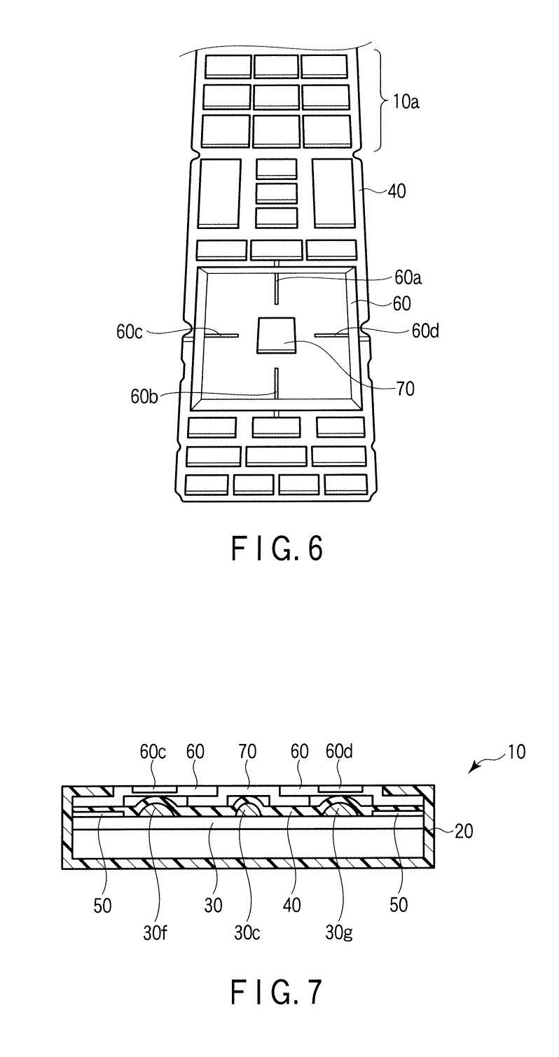

FIG. 6 is a top view schematically illustrating the touchpad 60 used in the remote controller 10. FIG. 6 illustrates that the touchpad 60 and the enter key 70 are provided on the top surface of the rubber 40 bonded to the printed board 30 by the seal 50 illustrated in FIG. 5. The touchpad 60 comprises an input screen in the surface thereof, and the enter key 70 also comprises an input screen in the surface thereof. The surface of the enter key 70 functions as a touchpad, like the touchpad 60. The touchpad 60 and the enter key 70 can be operated by a continuous rubbing operation made thereon. The input screen of the touchpad 60 is located so as to surround the input screen of the enter key 70.

The touchpad 60 is located to be opposed to the area of the touchpad electrode 30b. The up key 60a is located to be opposed to the up-key metal dome 30d. The same as described above also applies to the down key 60b, left key 60c, and right key 60d. The enter key 70 is also located to be opposed to the enter key metal dome 30c.

FIG. 7 is a cross-sectional view of the remote controller 10 cut along a line X-X in FIG. 1. Ends of the touchpad 60 are engaged into the housing 20. That is, the ends of the touchpad 60 are sandwiched between the rubber 40 and the housing 20. The housing 20 positions a gap between the touchpad 60 and the printed board 30. FIG. 7 illustrates ends of the touchpad 60 in the sides of the left key 60c and right key 60d. The other ends in the sides of the up key 60a and down key 60b have the same configuration as illustrated herein. Therefore, when the user pushes down a direction key, the direction key moves down and up without allowing the housing 20 to obstruct the operation of pushing down.

Ends of the enter key 70 are engaged into the housing 20 by the touchpad 60. That is, the ends of the enter key 70 are sandwiched between the rubber 40 and the touchpad 60. The housing 20 and the touchpad 60 position a gap between the enter key 70 and the printed board 30. FIG. 7 illustrates ends of the enter key 70 in the left and right sides. The other ends in the front and rear sides have the same configuration as illustrated. Therefore, when the user pushes down the enter key 70, the enter key 70 independently moves down and up without allowing the touchpad 60 to obstruct the operation of pushing down.

According to the embodiment, the rubber 40 and the printed board 30 are fixed by bonding, at positions where the rubber 40 and the printed board 30 are opposed to the area of the touchpad 60 including the operation keys. Therefore, the user can accurately operate the touchpad 60. Even in the rubber 40 and printed board 30 positioned to be opposed to the touchpad 60, parts of the up-key metal dome 30d, down-key metal dome 30e, left-key metal dome 30f, and right-key metal dome 30g, which are opposed to the direction keys, are not fixed by bonding. A part of the enter key metal dome 30c which is opposed to the enter key 70 is not fixed by bonding, as well. Accordingly, the user can surely feel a click when pushing down any of the direction keys and the enter key 70.

Although the embodiment has described the remote controller 10 which mounts the touchpad 60, the embodiment is not limited to this remote controller. The remote controller 10 may be of a wired or wireless type. Further, the embodiment is applicable to a small device into which, for example, the touchpad 60 and the display are integrated.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A small device comprising:
a first touchpad with a first input surface on a surface of the first touchpad;
a second touchpad with a second input surface on a surface of the second touchpad, the second input surface allowing a rubbing operation continuing from the first input surface of the first touchpad;
a board with a first detector configured to detect push-down input from the first touchpad and second detector configured to detect input by the rubbing operation,
the first detector being provided at a position where the first detection section is opposed to the first touchpad, and
the second detector being provided at a position where the second detection section is opposed to the second touchpad; and
a housing which positions the second touchpad and the board and covers the board.

2. The device of claim 1, comprising an elastic member between the second touchpad and the second detector.

3. The device of claim 2, wherein the elastic member is fixed to the second detector.

4. The device of claim 3, comprising a double-faced adhesive member which bonds the elastic member and the second detector.

5. The device of claim 4, wherein the elastic member is unfixed to the first detector.

6. The device of claim 1, wherein the second input surface of the second touchpad is located so as to surround the first input surface of the first touchpad.

7. The device of claim 1, comprising a third detector which detect push-down input at a predetermined portion of the second touchpad.

8. The device of claim 1, wherein the third detector is unfixed to the elastic member.
